(19) United States
(12) Patent Application Publication
(10) Pub. No.: US 2019/0039848 A1
(43) Pub. Date: Feb. 7, 2019

(54) SHEET STACKING APPARATUS AND IMAGE FORMING APPARATUS

(71) Applicant: CANON KABUSHIKI KAISHA, Tokyo (JP)

(72) Inventor: Tadahisa Sugiyama, Tsukubamirai-shi (JP)

(21) Appl. No.: 16/044,965

(22) Filed: Jul. 25, 2018

(30) Foreign Application Priority Data
Aug. 1, 2017 (JP) 2017-148979

(51) Int. Cl. B65H 31/34; G03G 15/00; B65H 31/26

(52) U.S. Cl. CPC B65H 31/34; B65H 31/26; G03G 15/6552

(57) ABSTRACT

It is desirable to improve alignment of sheets discharged to a stack tray without increasing the size and cost of the apparatus.

A stacking portion which is sloped so that a downstream side is higher than an upstream side in a sheet conveyance direction and on which a sheet discharged by a discharging portion is stacked and a plurality of rotation members which protrudes from an upper face of the stacking portion are provided. At least one of the plurality of rotation members rotates only in a direction opposite to the sheet conveyance direction.

### BACKGROUND OF THE INVENTION

### Field of the Invention

The present invention relates to a sheet stacking apparatus for stacking discharged sheets and an image forming apparatus provided with the sheet stacking apparatus.

### Description of the Related Art

Generally, image forming apparatuses such as copying machines, facsimile machines, and printers have a sheet stacking portion for stacking sheets on which images are formed by an electrophotographic system or the like. Specifically, an image forming apparatus in which the stack tray is provided on the side of the apparatus main body, and an image forming apparatus of the in-body discharge type having the in-body stack tray below the image reading section above the apparatus main body are known.

A function of the sheet stacking portion includes a function in which discharged sheets are aligned and stacked. Specifically, a widely used configuration is such that the stack tray is sloped so that the downstream side is higher than the upstream side in the sheet conveyance direction, and the trailing end of the sheet is brought into contact with and aligned to the alignment reference plane provided on the upstream side in the conveyance direction by falling of the sheet by its own weight.

In recent years, compactness of the image forming apparatus is demanded, and it is desired to reduce the height of the image forming apparatus. As a result, the image forming apparatus of the in-body discharge type having the sheet stacking portion inside the body of the apparatus has a narrower inside space as the apparatus height decreases. When the inside space of the apparatus is narrowed, there is a problem in that a difference in elevation between the upstream side and the downstream side of the stack tray cannot be obtained sufficiently, and the effect of falling of the sheet by its own weight is reduced, resulting in deterioration of alignment.

In order to solve the above problem, the configurations of Japanese Patent Laid-Open No. 2014-114119 and Japanese Patent Laid-Open No. 2006-1730 have been offered. In Japanese Patent Laid-Open No. 2014-114119, the configuration is offered in which sheets are pressed by a pressing member that presses a sheet, conveyed in a direction different from the conveyance direction by a roller, and forcibly brought into contact with the alignment reference plane so that the sheets are aligned.

Further, in Japanese Patent Laid-Open No. 2006-1730, in the configuration in which the sheets are aligned at the downstream end in the sheet conveyance direction by falling of the sheet by its own weight, a rotation member is provided which can be moved up and down so as to be capable of protruding or retracting with respect to the stack tray face, and is rotatable. In this Japanese Patent Laid-Open No. 2006-1730, while the sheets are being discharged, the rotation member is retracted below the stack tray face so as to stand by without contacting the sheets. After the discharge of the sheets is completed, the rotation member is moved upward so as to protrude from the stack tray face, and is brought into contact with the sheets, thereby urging the sheet to fall by its own weight due to the driven rotation of the rotation member, and making it easy for the trailing end of the sheet to contact the alignment reference plane.

However, as disclosed in Japanese Patent Laid-Open No. 2014-114119, in the configuration in which the sheets are conveyed by a roller and forcibly brought into contact with the alignment reference plane, it is necessary to drive the roller, thereby increasing the size and cost of the apparatus.

In addition, as disclosed in Japanese Patent Laid-Open No. 2006-1730, in the configuration in which the rotation member protrudes with respect to the stack tray face after the discharge of the sheets is completed, it is possible to align the bundle of stacked sheets. However, the problem with misalignment of each sheet in the bundle of stacked sheets cannot be solved. In the technique of aligning sheets by falling of the sheet by its own weight, when the friction resistance force between the sheet and the tray or between the sheets is larger than the falling force due to the self-weight of the sheet, the sheet cannot move toward the downstream side in the conveyance direction, resulting in deterioration of alignment. Since the frictional resistance between the sheet and the tray is often higher than the frictional resistance between the sheets, misalignment between the first sheet and the second sheet is particularly likely to occur. However, the configuration of Japanese Patent Laid-Open No. 2006-1730, cannot solve this problem. In addition, since the position of the rotation member is moved, the size and cost of the apparatus are increased.

### SUMMARY OF THE INVENTION

It is desirable to improve alignment of sheets discharged to a stack tray without increasing the size and cost of the apparatus.

To achieve the above object, a sheet stacking apparatus according to the present invention includes: a stacking portion which is sloped so that a downstream side is higher than an upstream side in a sheet conveyance direction and on which a sheet discharged by a discharging portion is stacked; and a plurality of rotation members disposed so as to protrude from an upper face of the stacking portion, wherein at least one of the plurality of rotation members rotates only in a direction opposite to the sheet conveyance direction.

According to the present invention, it is possible to improve alignment of sheets discharged to a stacking portion without increasing the size and cost of the apparatus.

Further features of the present invention will become apparent from the following description of exemplary embodiments with reference to the attached drawings.

### BRIEF DESCRIPTION OF THE DRAWINGS

FIG. 1 is a simplified sectional view of an image forming apparatus.

FIGS. 2A to 2D are schematic diagrams of the sheet alignment flow of the image forming apparatus.

FIGS. 3A to 3F are schematic diagrams when the alignment at the time of sheet stacking is deteriorated.

FIG. 4 is a schematic perspective view of a sheet stacking portion according to the present embodiment.

FIGS. 5A to 5C are schematic diagrams of the sheet alignment flow of the sheet stacking portion according to the present embodiment.

FIGS. 6A and 6B are schematic diagrams at the time of sheet conveyance when a rotation member is rotatable in the sheet conveyance direction.

### DESCRIPTION OF THE EMBODIMENTS

Preferred embodiments of the present invention will be described in detail below with reference to the accompanying drawings. However, the dimensions, materials, shapes, relative positions thereof, and the like of the components described in the following embodiments should be appropriately changed depending on the configuration of the apparatus to which the present invention is applied and various conditions. Therefore, unless otherwise specified, the scope of the present invention is not limited to them.

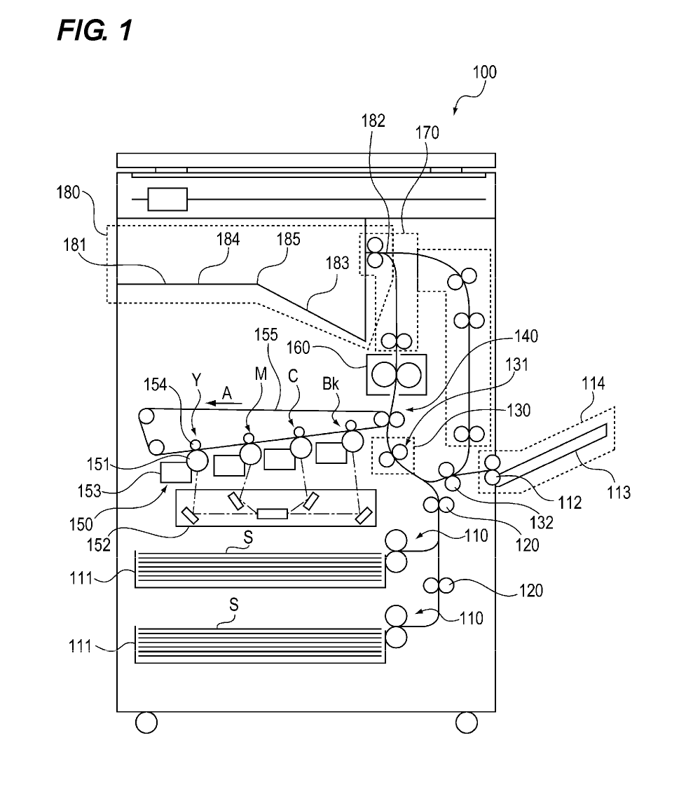

Hereinafter, an image forming apparatus including a sheet stacking portion (a sheet stacking apparatus) according to the present embodiment will be described in detail with reference to FIGS. 1 to 6B. FIG. 1 is a schematic sectional view of the image forming apparatus having the sheet stacking portion.

In the image forming apparatus shown in FIG. 1, laser light is emitted from a laser scanner unit 152 to form an electrostatic latent image on a photosensitive drum 151, the electrostatic latent image on the photosensitive drum is developed by a development device 153, and a toner image is formed on the photosensitive drum. Thereafter, a predetermined pressure force and electrostatic load bias are applied by a primary transfer unit 154, and the toner image is transferred onto an intermediate transfer belt 155. In the case of FIG. 1, image forming portions 150 include four sets of yellow Y, magenta M, cyan C, and black Bk.

Next, the intermediate transfer belt 155 will be described. The intermediate transfer belt 155 is rotationally driven in the direction of arrow A in FIG. 1. Therefore, the parallel process is performed by each image forming portion 150 of Y, M, C, and Bk. The image forming process of each color is performed at the timing of carrying out superposition on the upstream toner image primarily transferred onto the intermediate transfer belt 155. As a result, a full-color toner image is finally formed on the intermediate transfer belt 155 and conveyed to a secondary transfer portion 156.

On the other hand, the sheets S stacked on a cassette 111 are separated and fed one by one by a paper feed portion 110. The fed sheets S are conveyed by a drawing roller 120 via a conveyance path 133 toward a sheet skew feeding correction device 130 disposed on the downstream side in the sheet conveyance direction (hereinafter simply referred to as “downstream”), and the skew feeding of the sheet S is corrected. Thereafter, the sheets S transferred to a pair of registration rollers 131 disposed further downstream are conveyed to a secondary transfer portion 140 by the pair of registration rollers 131.

A full-color toner image is secondarily transferred onto the sheets S in the secondary transfer portion 140 by the conveyance process and the image forming process of the sheet S described above. Thereafter, the sheets S are conveyed to a fixing unit 160. The fixing unit 160 melts and fixes (fixes) the toner onto the sheets S by applying a predetermined pressure by substantially opposing rollers or a belt, and a heating effect by a heat source such as a heater, generally. The sheet S having the fixed image obtained in this manner passes through a post-fixing conveying portion 170 and is discharged by a discharge roller 182 as a discharging portion onto a stack tray 181 of a sheet stacking portion 180 placed in the body of an image forming apparatus 100.

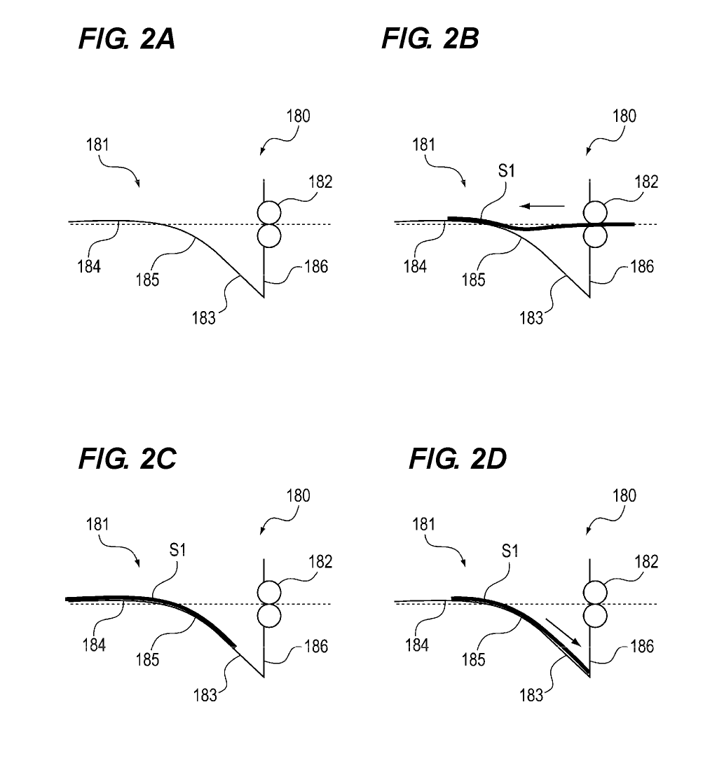

With reference to FIGS. 2A to 2D, a configuration in which the trailing ends of the sheets are brought into contact with each other by falling of the sheet by its own weight will be described as a configuration for aligning and stacking the discharged sheets. FIGS. 2A to 2D are schematic diagrams of the sheet alignment flow of the image forming apparatus. FIG. 2A is a schematic view of the sheet stacking portion, FIG. 2B is a schematic diagram when the sheet is conveyed by the discharge roller, FIG. 2C is a schematic diagram when the sheet passes through the discharge roller, and FIG. 2D is a schematic diagram when the sheets are aligned by falling by self-weight.

As shown in FIG. 2A, a slope is formed on the stack tray 181 as a stacking portion so that the downstream side is higher than the upstream side in the sheet conveyance direction. The stack tray 181 includes a first stacking portion 183 on the upstream side in the sheet conveyance direction and a second stacking portion 184 on the downstream side which have different slopes. The first stacking portion 183 has the slope and is a first stacking plane on which sheets are stacked. The second stacking portion 184 is connected to the downstream side of the first stacking portion 183 in the sheet conveyance direction and is a second stacking plane on which sheets are stacked. In addition, in the stack tray 181, the first stacking portion 183 and the second stacking portion 184 are formed such that the first stacking portion 183 is disposed at a higher position and has a gentle slope through a connection portion 185. In the stack tray 181, an alignment reference plane 186 for aligning and stacking the trailing end of the sheets which is brought into contact with the alignment reference plane 186 is connected with the downstream position of the first stacking portion 183 in the sheet conveyance direction.

As shown in FIG. 2B, a sheet S1 nipped by the discharge roller 182 comes into contact with the second stacking portion 184 of the stack tray 181 as it is conveyed. Further, as shown in FIG. 2C, when the trailing end of the sheet S1 is discharged from the discharge roller 182, the trailing end of the sheet S1 comes into contact with the first stacking portion 183. Thereafter, due to the slope formed in the first stacking portion 183, the sheet S1 falls by its own weight, and the trailing end of the sheet S1 comes into contact with the alignment reference plane 186 as shown in FIG. 2D, so that the stacking of the sheet S1 completes.

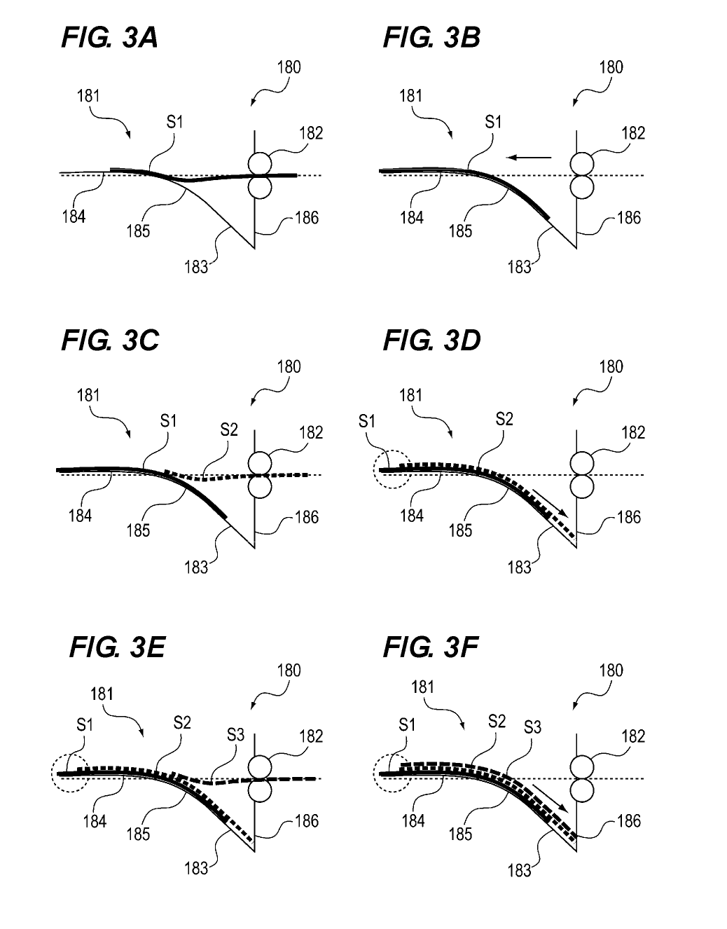

Next, a state when alignment of sheets is disturbed will be described with reference to FIGS. 3A to 3F. FIGS. 3A to 3F are schematic diagrams when the alignment at the time of sheet stacking deteriorates. FIG. 3A is a schematic diagram when a first sheet is being conveyed, and FIG. 3B is a schematic diagram when the first sheet is stacked without falling by self-weight. FIG. 3C is a schematic diagram when a second sheet is being conveyed, and FIG. 3D is a schematic diagram when the second sheet is stacked by falling by self-weight. FIG. 3E is a schematic diagram when a third sheet is being conveyed, and FIG. 3F is a schematic diagram when the third sheet is stacked by falling by self-weight.

Conventionally, resin is often used as a material of a stack tray. The frictional resistance between the sheet and the resin becomes large particularly in a state where the moisture content contained in the sheet and the environmental humidity where the image forming apparatus is placed are high. In this case, as shown in FIGS. 3A and 3B, the first sheet S1 cannot completely fall by its own weight, and the first sheet S1 may stop before the trailing end of the sheet reaches the alignment reference plane 186. Thereafter, as shown in FIG. 3C, the second sheet S2 is conveyed, the trailing end of the sheet S2 comes out of the discharge roller 182, and the sheet falls by its own weight. However, if the frictional resistance between the sheets is small, the second sheet S2 falls along the slope of the first stacking portion 183 on the first sheet S1, and the trailing end of the sheet S2 stops after it comes into contact with the alignment reference plane 186. At this time, as shown in FIG. 3D, the first sheet S1 and the second sheet S2 are stacked without being aligned in the sheet conveyance direction. After that, the third and subsequent sheets are conveyed. However, as shown in FIGS. 3E and 3F, similarly to the second sheet, the third and subsequent sheets fall down along the slope on the previously discharged sheet to stop after coming into contact with the alignment reference plane 186. Therefore, when the discharging of the sheet is completed, only the first sheet protrudes with respect to the other sheets, resulting in deterioration of alignment.

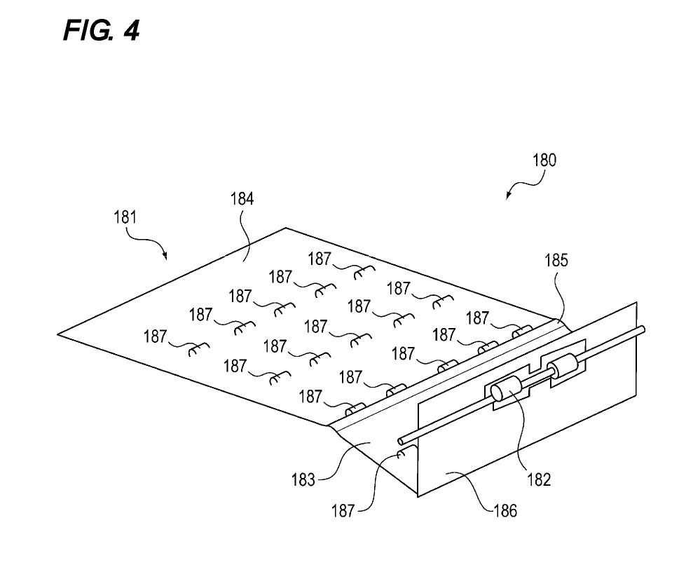

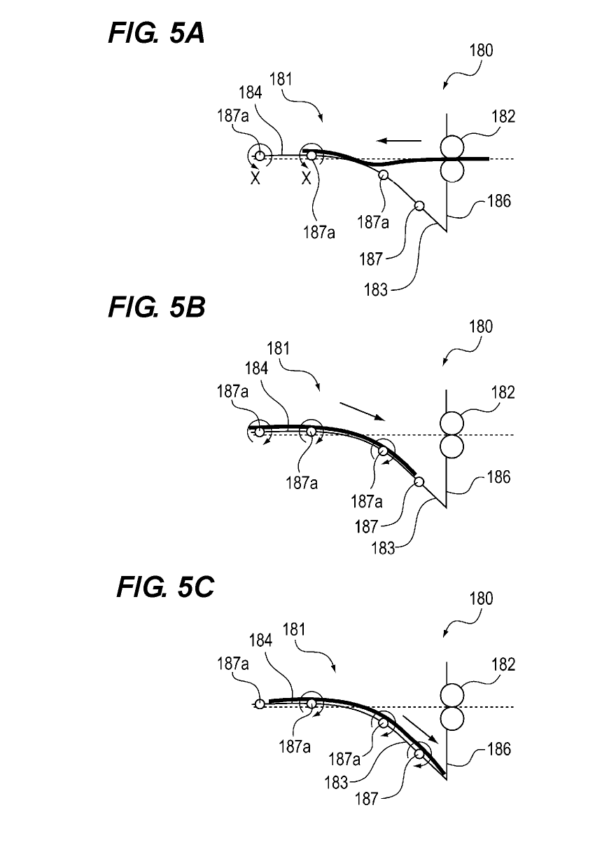

Therefore, the sheet stacking portion 180 according to the present embodiment has a plurality of rotation members 187 disposed to protrude from the upper face of the stack tray 181. Here, the sheet stacking portion 180 according to the present embodiment will be described with reference to FIGS. 4 to 5C FIG. 4 is a schematic perspective view of the sheet stacking portion according to the present embodiment. FIGS. 5A to 5C are schematic diagrams of the sheet alignment flow of the sheet stacking portion according to the present embodiment. FIG. 5A is a schematic diagram when the first sheet is being conveyed, FIG. 5B is a schematic diagram when the first sheet is stacked with falling by self-weight being promoted by the rotation member, and FIG. 5C is a schematic diagram when the first sheet is stacked.

As shown in FIG. 4, the sheet stacking portion 180 has the plurality of rotation members 187 disposed to protrude from the upper face of the stack tray 181. The rotation members 187 protrude from the upper face of the stack tray 181 so as to be rotatable, and are disposed in the sheet conveyance direction. The plurality of rotation members 187 is disposed in the width direction orthogonal to the sheet conveyance direction. The plurality of rotation members 187 can be disposed in the sheet conveyance direction and the width direction. There are few cases that the shape of the sheet at the time of discharging is plane because a wavy shape is formed by a stiffness member (not shown) for imparting stiffness to the sheet, a curl is formed by heat or toner, and the like. Therefore, in order to securely bring the rotation member and the sheet into contact with each other, the plurality of rotation members 187 can be disposed in the width direction orthogonal to the sheet conveyance direction. Further, in order to efficiently promote falling of the sheet by its own weight, the plurality of rotation members 187 can be disposed also in the sheet conveyance direction. The rotation members 187 can be disposed at each position of at least the first stacking portion 183, the second stacking portion 184, and the connection portion 185 of the stack tray 181.

Furthermore, as shown in FIGS. 5A to 5C, among the plurality of rotation members 187, some rotation members include a one-way rotation member 187a configured to be rotatable only in one direction. That is, the one-way rotation member 187a among the plurality of rotation members is a rotation member that does not rotate in the sheet conveyance direction but rotates only in the direction opposite to the sheet conveyance direction.

The discharge roller 182 may be speed-controlled so as to reliably convey the trailing end of the sheet so that the trailing end of the sheet at the time of discharging does not remain at the nip portion of the discharge roller 182. As one example, control is performed so that the conveying speed at the trailing end of the sheet is increased. In this control, since the sheets are conveyed at a high speed in the conveyance direction, the control is such that alignment at the sheet trailing end which is positioned at a place in the direction opposite to the sheet conveyance direction is prevented. The one-way rotation member 187a which does not rotate in the sheet conveyance direction is disposed so as not to impair the alignment of the sheets even if this speed control is performed. As a result, the leading end of the sheet coming out of the discharge roller 182 drops (contacts) onto the second stacking portion 184. At this time, the sheet dropped on (contacting) the second stacking portion 184 contacts the rotation member 187a protruding from the upper face of the second stacking portion 184 as shown in FIG. 5A. The sheet discharged and conveyed by the discharge roller 182 is restrained from moving in the sheet conveyance direction by the rotation member 187a in contact with the sheet. As a result, it is possible to prevent deterioration of the alignment caused by the discharged sheets moving in the sheet conveyance direction (discharge direction).

Further, as shown in FIG. 5B, when the trailing end of the sheet passes through the nip portion of the discharge roller 182, the trailing end of the sheet drops onto (contact) the first stacking portion 183 of the stack tray 181, and falls along the slope of the stack tray 181 due to its own weight. At this time, the sheet dropped on (contacting) the first stacking portion 183 of the stack tray 181 contacts the rotation member 187 disposed so as to protrude from the upper face of the first stacking portion 183, and due to the driven rotation in the direction opposite to the sheet conveyance direction of the contacted rotation member 187, falling of the sheet by its own weight is promoted. As a result, as shown in FIG. 5C, the end portion of the sheet surely comes into contact with the alignment reference plane 186, and good alignment with the sheet to be discharged onto the already stacked sheet can be maintained. In addition, since the rotation member 187 disposed so as to protrude from the upper face of the first stacking portion 183 rotates by following the sheet falling by its own weight along the slope of the stack tray 181, it is possible to improve alignment of the sheets discharged to the stack tray 181 continuously without increase in the size and cost of the apparatus. That is, the operation in which the rotation member 187 follows the first sheet that is discharged onto the stack tray 181 and falls along the slope of the stack tray 181 is performed before the trailing end of the second sheet, which is stacked after the first sheet, passes through the nip portion of the discharge roller 182 (before discharging). Therefore, it is possible to ensure good alignment between the first sheet and the subsequent sheets including the second sheet.

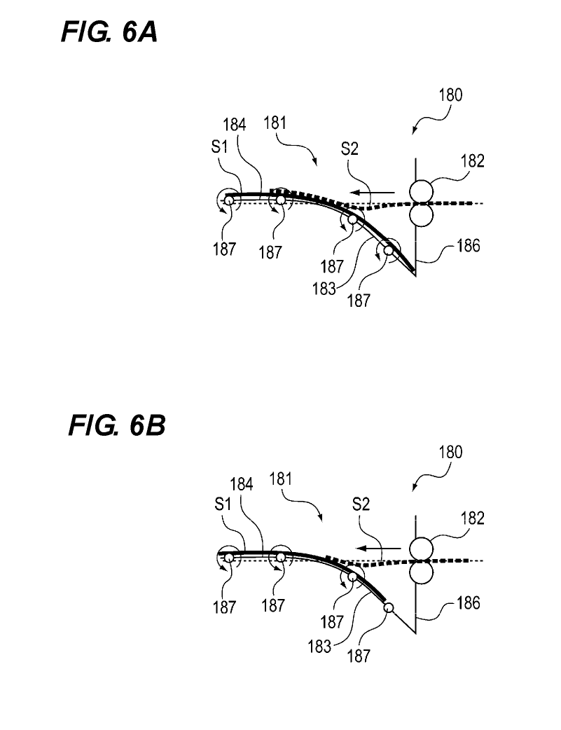

Further, by using only the rotation member 187 that can rotate in both the sheet conveyance direction and the reverse direction without using the one-way rotation member 187a, it is possible to promote the above-described falling of the sheet by its own weight. However, in the case of this configuration, a frictional force due to contact with the sheet being discharged may promote movement of the already stacked sheets. This will be described in detail with reference to FIGS. 6A and 6B. FIGS. 6A and 6B are schematic diagrams of sheet conveyance when the rotation member is rotatable in the sheet conveyance direction. FIG. 6A is a schematic diagram when the second sheet is being conveyed, and FIG. 6B is a schematic diagram when the second sheet pushes out the first sheet. As shown in FIGS. 6A and 6B, although the trailing end of the sheet S1 already stacked on the stack tray 181 comes into contact with the alignment reference plane 186, the sheet S1 is in contact with only the rotation member 187 which is rotatable also in the sheet conveyance direction. When the sheet S2 is discharged onto the already stacked sheet S1 by the discharge roller 182, the rotation member 187, which is rotatable also in the sheet conveyance direction and is in contact with the already stacked sheet S1, may promote movement of the already stacked sheet S1 in the sheet conveyance direction (discharge direction) by the frictional force due to the contact with the sheet S2 being discharged. On the other hand, in the present embodiment, as described above, the one-way rotation member 187a is disposed on part of the plurality of rotation members. As a result, the one-way rotation member among the rotation members in contact with the already stacked sheet does not rotate in the sheet conveyance direction, so that it is possible to prevent deterioration of alignment because the already stacked sheet S1 is pushed out by the sheet S2 being discharged.

It should be noted that the one-way rotation member 187a may be disposed only at a position where it comes into contact with the sheet when the sheet comes out of the discharge roller 182, and it is not necessary that all the rotation members 187 are the one-way rotation member 187a. For example, in the case of the arrangement relation between the discharge roller 182 and the stack tray 181 as shown in FIGS. 5A to 5C, the following configuration can be employed. As shown in FIGS. 5A to 5C, according to the relationship between the nip height of the discharge roller 182 (the dotted line position in the figure) and the height of the stack tray 181, the first stacking portion 183 does not come into contact with the sheet until the sheet trailing end comes out of the discharge roller 182. Therefore, the one-way rotation member 187a may be disposed only in the second stacking portion 184 (and the connection portion 185).

Further, it is desirable that the protruding amount of the rotation member 187 from the upper face of the stack tray 181 is as small as possible. This is because when the rotation member 187 protrudes largely from the upper face of the stack tray 181, the sheet has a convex shape at the upstream side and the downstream side in the sheet conveyance direction with respect to the central axis of the rotation member 187, preventing falling of the sheet by its own weight in the direction opposite to the sheet conveyance direction. Therefore, in the present embodiment, the amount of the protrusion of the rotation member 187 including the rotation member 187a from the upper face of the stack tray 181 is about 0.5 mm.

As described above, according to the present embodiment, it is possible to improve alignment of the sheets discharged to the stack tray without complicating the apparatus, and increasing the size and cost of the apparatus.

In the above-described embodiment, the image forming apparatus having the sheet stacking portion in the body has been described as an example. The image forming apparatus having the sheet stacking portion on the side of the apparatus body has the same effects. The present invention is not limited to the configuration having a sheet stacking portion in the body.

Further, in the above-described embodiment, a copying machine is exemplified as the image forming apparatus. However, the present invention is not limited thereto. For example, the embodiment may include other image forming apparatuses such as a printer, a facsimile apparatus, or a multifunction machine with a combination of these functions. In addition, although the image forming apparatus has been exemplified in which an intermediate transfer member is used, toner images of respective colors are transferred in a sequentially superimposed manner onto the intermediate transfer member, and the toner images carried on the intermediate transfer member are collectively transferred onto a sheet, the present invention is not limited thereto. For example, the embodiment may be an image forming apparatus that uses a sheet carrier and transfers in a sequentially superimposed manner toner images of respective colors onto a sheet carried on the sheet carrier. By applying the present invention to these image forming apparatuses, the same effects can be obtained.

Further, in the above-described embodiment, the sheet stacking apparatus (sheet stacking portion) integrally provided in the image forming apparatus is exemplified. However, the present invention is not limited thereto. For example, the sheet stacking apparatus may be attachable to and/or detachable from the image forming apparatus, and the same effect can be obtained by applying the present invention to the sheet stacking apparatus.

Further, in the above-described embodiment, the sheet stacking apparatus for stacking sheets such as recording paper as a recording target is exemplified. However, the present invention is not limited thereto. For example, the same effect can be obtained by applying the present invention to a sheet stacking apparatus that stacks sheets of an original or the like as an object to be read.

In the above-described embodiment, the electrophotographic system is exemplified as the recording method. However, the present invention is not limited to this, and other recording methods such as an inkjet method may be used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-148979, filed Aug. 1, 2017, which is hereby incorporated by reference herein in its entirety.

What is claimed is:

1. A sheet stacking apparatus comprising:
a stacking portion which is sloped so that a downstream side is higher than an upstream side in a sheet conveyance direction and on which a sheet discharged by a discharging portion is stacked; and
a plurality of rotation members disposed so as to protrude from an upper face of the stacking portion,
wherein at least one of the plurality of rotation members rotates only in a direction opposite to the sheet conveyance direction.

2. The sheet stacking apparatus according to claim 1,
wherein the stacking portion has the slope and includes a first stacking plane on which a sheet is stacked and a second stacking plane on which the sheet is stacked, the second stacking plane being connected to a downstream side of the first stacking plane in the sheet conveyance direction.

3. The sheet stacking apparatus according to claim 2,
wherein the rotation members are disposed on each of the first stacking plane and the second stacking plane of the stacking portion.

4. The sheet stacking apparatus according to claim 2,
wherein among the plurality of rotation members, a rotation member that rotates only in a direction opposite to the sheet conveyance direction is disposed on the second stacking plane of the stacking portion.

5. The sheet stacking apparatus according to claim 1,
wherein the rotation members rotate by following a sheet falling by self-weight along the slope of the stacking portion.

6. A sheet stacking apparatus comprising:
a stacking portion which is sloped so that a downstream side is higher than an upstream side in a sheet conveyance direction and on which a sheet discharged by a discharging portion is stacked; and
a rotation member disposed so as to protrude from an upper face of the stacking portion,
wherein when a first sheet and a second sheet following the first sheet are continuously discharged by the discharging portion, the rotation member rotates by following the first sheet falling by self-weight along the slope of the stacking portion before the second sheet is discharged by the discharging portion.

7. The sheet stacking apparatus according to claim 1,
wherein the rotation members are disposed in a width direction orthogonal to the sheet conveyance direction.

8. The sheet stacking apparatus according to claim 1,
wherein the rotation members are disposed in the sheet conveyance direction.

9. An image forming apparatus comprising:
an image forming portion that forms an image on a sheet; and
a sheet stacking apparatus that stacks a sheet discharged by a discharging portion;
wherein the sheet stacking apparatus includes:
a stacking portion which is sloped so that a downstream side is higher than an upstream side in a sheet conveyance direction and on which a sheet discharged by the discharging portion are stacked; and
a plurality of rotation members disposed so as to protrude from an upper face of the stacking portion, and
wherein at least one of the plurality of rotation members rotates only in a direction opposite to the sheet conveyance direction.

10. The image forming apparatus according to claim 9,
wherein the stacking portion has the slope and includes a first stacking plane on which a sheet is stacked and a second stacking plane on which the sheet is stacked, the second stacking plane being connected to a downstream side of the first stacking plane in the sheet conveyance direction.

11. The image forming apparatus according to claim 10,
wherein the rotation members are disposed on each of the first stacking plane and the second stacking plane of the stacking portion.

12. The image forming apparatus according to claim 11,
wherein among the plurality of rotation members, a rotation member that rotates only in a direction opposite to the sheet conveyance direction is disposed on the second stacking plane of the stacking portion.

13. The image forming apparatus according to claim 9,
wherein the rotation members rotate by following a sheet falling by self-weight along the slope of the stacking portion.

14. An image forming apparatus comprising:
an image forming portion that forms an image on a sheet; and
a sheet stacking apparatus that stacks a sheet discharged by a discharging portion,
wherein the sheet stacking apparatus includes:
a stacking portion which is sloped so that a downstream side is higher than an upstream side in a sheet conveyance direction and on which a sheet discharged by the discharging portion are stacked; and
a rotation member protruding from an upper face of the stacking portion, and
wherein when a first sheet and a second sheet following the first sheet are continuously discharged by the discharging portion, the rotation member rotates by following the first sheet falling by self-weight along the slope of the stacking portion before the second sheet is discharged by the discharging portion.

15. The image forming apparatus according to claim 9,
the rotation members are disposed in a width direction orthogonal to a sheet conveyance direction.

16. The image forming apparatus according to claim 9,
wherein the rotation members are disposed in the sheet conveyance direction.
